(19) United States
(12) Patent Application Publication
(10) Pub. No.: US 2018/0141031 A1
(43) Pub. Date: May 24, 2018

(54) MULTI-ZONED SYNERGIZED-PGM CATALYSTS FOR TWC APPLICATIONS

(71) Applicant: Clean Diesel Technologies, Inc., Oxnard, CA (US)

(72) Inventors: Zahra Nazarpoor, Camarillo, CA (US); Stephen J. Golden, Santa Barbra, CA (US)

(21) Appl. No.: 15/358,827

(22) Filed: Nov. 22, 2016

(51) Int. Cl. B01J 35/04; B01J 23/00; B01J 23/40; B01J 23/889; B01J 23/89; B01J 23/58; B01J 23/44; B01J 23/46; B01J 35/00; B01D 53/94; F01N 3/28

(52) U.S. Cl. CPC B01J 35/04; F01N 2510/068; B01J 23/40; B01J 23/8892; B01J 23/8986; B01J 23/58; B01J 23/44; B01J 23/464; B01J 35/0006; B01D 53/9468; B01D 53/9472; F01N 3/2803; B01D 2255/1023; B01D 2255/1025; B01D 2255/908; B01D 2255/20738; B01D 2255/20761; B01D 2255/2073; B01D 2255/2042; B01D 2255/20715; B01D 2255/40; B01D 2255/9027; B01D 2255/9025; B01D 2255/9032; B01D 2255/2092; B01J 23/005

(57) ABSTRACT

Multi-zoned synergized-platinum group metals (SPGM) catalysts with significant catalytic capabilities are disclosed. The multi-zoned SPGM catalysts are produced according to catalyst configurations including OC layers of ultra-low PGM loadings, alone or in combination with a base metal oxide, which are deposited onto either mixtures of doped ZrO₂ and oxygen storage materials (OSM) or OSM alone. Further, the multi-zoned SPGM catalysts further include zoned impregnation layers with PGM, alone or in combination with Ba loadings. Additionally, three-zoned SPGM catalysts are produced including front and back zone catalysts that include binary spinel oxide compositions. Conversion performance of the aged SPGM catalysts and an aged PGM-based OEM catalyst are tested employing TWC low perturbation isothermal oscillating, isothermal steady-state sweep, and light-off test methodologies. Test results confirm the SPGM catalysts including ultra-low PGM loadings and spinel-based ZPGM WC layer are capable of providing significant conversion performance that is comparable to high PGM-based OEM catalyst.

### BACKGROUND

### Field of the Disclosure

The present disclosure relates generally to three-way catalyst (TWC) systems, and more particularly, to synergized-PGM catalysts with catalyst configurations including multi-zoned layers for the reduction of toxic emissions from engine exhaust systems.

### Background Information

Catalysts within catalytic converters have been used to decrease the pollution associated with exhaust from various sources, such as, for example automobiles, motorcycles, boats, generators, and other engine-equipped machines. Significant pollutants contained within the exhaust gas of gasoline engines include carbon monoxide (CO), unburned hydrocarbons (HC), and nitrogen oxides (NO_{X} ), amongst others.

Conventional gasoline exhaust systems employ three-way catalysts (TWC) technology and are referred to as TWC systems. TWC systems convert the toxic CO, HC, and NO_{X} into less harmful pollutants. Typically, TWC systems include a substrate structure upon which a layer of supporting and sometimes promoting oxides are deposited. Catalysts, based on platinum group metals (PGM), are then deposited upon the supporting oxides. Conventional PGM materials include platinum (Pt), palladium (Pd), rhodium (Rh), iridium (Ir), or combinations thereof.

Although PGM materials are effective for toxic emission control, PGM materials are scarce and expensive. The high cost remains a critical factor for widespread applications of PGM materials. As changes in the formulation of catalysts continue to increase the cost of TWC systems, the need for new low cost catalysts having improved catalytic performance has directed efforts toward the development of new catalytic materials capable of providing the required synergies to achieve greater catalytic performance. Additionally, compliance with ever stricter environmental regulations and the need for lower manufacturing costs require new types of TWC systems. Therefore, there is a continuing need to provide TWC systems employing reduced amounts of PGM materials that exhibit catalytic properties substantially similar to or exceeding the catalytic properties exhibited by conventional TWC systems employing standard amounts of PGM materials.

### SUMMARY

The present disclosure describes multi-zoned synergized-platinum group metals (SPGM) catalysts produced according to varied catalyst configurations. In some embodiments, the multi-zoned SPGM catalysts are produced according to a catalyst configuration that includes a substrate, a washcoat (WC) layer, a zoned-impregnation (ZIMP) layer, and an overcoat (OC) layer. In these embodiments, the WC layer includes support oxides combined with oxygen storage materials (OSM), which is coated onto the substrate. Further to these embodiments, the ZIMP layer includes PGM compositions configured within an inlet and an outlet zone, which each zone is impregnated onto associated portion of the WC layer. In these embodiments, the OC layer includes ultra-low PGM loading compositions that are deposited onto either support oxides combined with OSM or OSM alone, and further coated onto the ZIMP layer. Examples of multi-zoned SPGM catalyst systems are described in International Patent Application Ser. No. PCT/IB2016/052877, filed May 17, 2016, the contents of which is hereby incorporated by reference in its entirety.

In other embodiments, the SPGM catalysts are three-zone catalysts produced according to a catalyst configuration. In these embodiments, the catalyst configuration includes a front-zone catalyst and a back-zone catalyst. Further to these embodiments, the front-zone catalyst is configured with a WC layer of support oxides combined with OSM and further coated onto a substrate. Still further to these embodiments, the front-zone catalyst additionally includes an impregnation (IMP) layer comprising PGM compositions that is impregnated onto the WC layer. In these embodiments, the front-zone catalyst further includes a 2-zone ZIMP layer comprising PGM compositions that are impregnated onto the IMP layer. Further to these embodiments, the front-zone catalyst includes an OC layer with ultra-low PGM loading compositions metalized on base metal oxide and deposited onto rare-earth (RE) metals-based OSM that is coated onto the ZIMP layer. Still further to these embodiments, the back-zone catalyst within the aforementioned three-zone SPGM catalysts is configured with a binary spinel-based zero-PGM (ZPGM) WC layer deposited onto support oxides that is coated onto a substrate. In these embodiments, the back-zone catalyst additionally includes an OC layer comprising PGM compositions metalized on base metal oxide and deposited onto RE metals-based OSM that is coated onto the ZPGM WC layer.

In some embodiments, a PGM composition includes platinum (Pt), palladium (Pd), ruthenium (Ru), iridium (Ir), and rhodium (Rh), either by themselves, or in combinations thereof employing different loadings. In these embodiments, the PGM composition within the catalyst configurations includes an overcoat (OC) layer of ultra-low Rh loadings within a range from about 1 g/ft³ to about 10 g/ft³, deposited onto either a combination of support oxides and OSM, or RE metals-based OSM alone. Further to these embodiments, the catalyst configurations include zoned-impregnation (ZIMP) and impregnation (IMP) layers with varied high PGM-based loadings of Pd within a range from about 10 g/ft³ to about 100 g/ft³, alone or in combination with Ba loadings.

In some embodiments, a ZPGM composition includes binary spinel structures with a general formulation A_{X}B_{3-X}O₄ in which X is a variable representing molar ratios within a range from about 0.01 to about 2.99. In these embodiments, A and B can be implemented as Na, K, Mg, Ca, Sr, Ba, Cr, Mn, Fe, Co, Ni, Cu, Zn, Cd, Al, Ti, Nb, Ce, La, Pr, Nd, Sm, Dy, In, or mixtures thereof, amongst others. Further to these embodiments, the binary spinel structures are deposited onto support oxides.

In an example, the ZPGM composition is implemented as a binary spinel structure of copper (Cu) and manganese (Mn). In this example, the Cu-Mn spinel structure is produced using a general formulation Cu_{X}Mn_{3-X}O₄ in which X takes a value of about 1.5 for a Cu_{1.5}Mn_{1.5}O₄ binary spinel structure. Further to this example, the Cu_{1.5}Mn_{1.5}O₄ binary spinel structure is deposited onto a doped Al₂O₃—ZrO₂ support oxide.

In some embodiments, the aforementioned multi-zoned SPGM catalysts and a PGM OEM reference catalyst are aged employing a fuel cut ZDAKW aging cycle protocol at about 1050° C. for about 20 hours and further tested employing a series of test procedures. In these embodiments, test procedures include: TWC low perturbation isothermal oscillating tests, TWC isothermal steady-state sweep tests, and TWC standard light-off tests. Test results confirm that multi-zoned SPGM catalysts are capable of providing substantially similar or higher performance improvement in NO_{X} reduction, and CO and THC oxidation when compared with the high PGM-based OEM catalysts, as well as being capable of playing a major role in overall conversion performance compared to the aforementioned high PGM-based OEM catalysts in TWC applications.

In one aspect, the invention is directed to a catalyst system for treating an exhaust stream of a combustion engine, comprising a front zone catalyst region and a back zone catalyst region disposed downstream of the front zone catalyst region.

In one embodiment, the front zone catalyst region comprises a substrate; a washcoat layer overlying the substrate; an impregnation layer overlying the washcoat layer, a zoned-impregnation layer overlying the impregnation layer, and an overcoat layer overlying the zoned-impregnation layer. In one embodiment, the impregnation layer comprises a platinum group metal, and the zoned-impregnation layer includes an inlet zone and an outlet zone downstream of the inlet zone in which the inlet zone comprises a platinum group metal and the outlet zone comprising a blank zone. The overcoat layer may comprise iron activated rhodium and a rare earth element-based oxygen storage material.

The back zone catalyst region may comprise a substrate; a washcoat layer overlying the substrate, wherein the washcoat layer comprising a support oxide and a binary spinel structure of the general formula A_{X}B_{3-X}O₄, and an overcoat layer overlying the washcoat layer and comprising iron activated rhodium and a rare earth element-based oxygen storage material.

In one embodiment, the washcoat layer of the back zone catalyst region comprises a support oxide and a binary spinel structure of the general formula A_{X}B_{3-X}O₄ wherein X is a variable ranging from 0.01 to 2.99, and A and B are selected from the group consisting of sodium, potassium, magnesium, calcium, strontium, barium, chromium, manganese, iron, cobalt, nickel, copper, zinc, cadmium aluminum, titanium, niobium, indium, cerium, lanthanum, praseodymium, neodymium, samarium, and dysprosium.

In one embodiment, the Xis selected from a variable ranging from 0.1 to 1.9, 0.2 to 1.8, 0.3 to 1.7, 0.4 to 1.6, and from 0.5 to 1.5. In a preferred embodiment, the binary spinel comprises a Cu—Mn spinel structure. For example, a Cu—Mn spinel structure having the formula Cu_{1.5}Mn_{1.5}O₄.

In one particular embodiment, the binary spinel comprises a Cu-Mn spinel structure. For example, the binary spinel may comprise a Cu—Mn spinel structure having the formula Cu_{1.5}Mn_{1.5}O₄.

In some embodiments, the platinum group metal in the impregnation layer is palladium having a loading from about 10 g/ft³ to about 100 g/ft³. In one particular embodiment, the platinum group metal in the impregnation layer is palladium having a loading of about 36.57 g/ft³. Typically, the loading of the platinum group metal in the impregnation layer is from about 30 to 40 g/ft³, and more typically, from about 32 to 38 g/ft³, and even more typically, from about 36 to 37 g/ft³.

In some embodiments, the impregnation layer may further comprises barium.

In one embodiment, the inlet zone of the zoned-impregnation layer is disposed towards an inlet end of the catalyst system, and the outlet zone of the zoned-impregnation layer is disposed towards an outlet end of the catalyst system.

In one embodiment, the platinum group metal in the inlet zone is present in a loading that is from about 10 g/ft³ to about 100 g/ft³. Typically, the loading of the platinum group metal in the inlet zone of the zoned-impregnation layer is from about 30 to 40 g/ft³, and more typically, from about 32 to 38 g/ft³, and even more typically, from about 36 to 37 g/ft³.

In some embodiments, the inlet zone of the zoned-impregnation layer further comprises barium.

In one embodiment, the overcoat layer of the front zone catalyst region comprises rhodium having a loading from about 1 to about 10 g/ft³, such as rhodium loading of about 4.3 g/ft³.

In one embodiment, the iron loading in the overcoat layer of the front zone catalyst region is from about 1 to about 10 percent by mass based on the total mass of the overcoat layer. In one particular embodiment, the iron loading in the overcoat layer of the front zone catalyst region is about 7 percent by mass based on the total mass of the overcoat layer.

In one embodiment, the washcoat layer of the front zone catalyst region comprises a rare earth element-based oxygen storage material and a support oxide, wherein the amount of rare earth element-based oxygen storage material to support oxide is a 1:1 mass ratio.

In one embodiment, the support oxide in the washcoat layer of the front zone region is selected from the group consisting of alumina, doped alumina, zirconia, doped zirconia, cerium oxide, titanium oxide, niobium oxide, silicon dioxide, and combinations thereof.

In some embodiments, the doped support oxide is doped with an oxide selected from the group consisting of calcium, strontium, barium, yttrium, lanthanum, neodymium, praseodymium, niobium, silicon, tantalum, and combinations thereof.

In one embodiment, the rare earth elements in the overcoat and washcoat layers of the front zone catalyst region are selected from the group consisting of praseodymium, cerium, neodymium, and combinations thereof.

In one embodiment, the washcoat layer of the front zone catalyst region comprises doped aluminum oxide (Al₂O₃) and a cerium based oxygen storage material (Ce-based OSM) in a 1:1 mass ratio.

In one embodiment, the support oxide in the washcoat layer of the back zone catalyst region is selected from the group consisting of alumina, doped alumina, zirconia, doped zirconia, cerium oxide, titanium oxide, niobium oxide, silicon dioxide, and combinations thereof In one such embodiment, the doped support oxide is doped with an oxide selected from the group consisting of calcium, strontium, barium, yttrium, lanthanum, neodymium, praseodymium, niobium, silicon, tantalum, and combinations thereof. In a preferred embodiment, the support oxide in the washcoat layer of the back zone catalyst region comprises doped Al₂O₃—ZrO₂.

In one embodiment, the overcoat layer of the back zone catalyst region comprises rhodium having a loading from about 1 to about 10 g/ft³, such as a rhodium loading of about 4.3 g/ft³.

In one embodiment, the iron loading in the overcoat layer of the back zone catalyst region is from about 1 to about 10 percent by mass based on the total mass of the overcoat layer.

In one particular embodiment, the iron loading in the overcoat layer of the back zone catalyst region is about 7 percent by mass based on the total mass of the overcoat layer.

A further aspect of the invention is directed to a catalyst system for treating an exhaust stream of a combustion engine, comprising a substrate; a washcoat layer overlying the substrate; a zoned-impregnation layer impregnated onto the washcoat layer, wherein the zoned-impregnation layer including an inlet zone comprising a platinum group metal and an outlet zone comprising a platinum group metal, wherein a loading of the platinum group metal in the outlet zone is less than a loading of the platinum group metal in the inlet zone; and an overcoat layer overlying the zoned-impregnation layer and comprising rhodium and a rare earth element-based oxygen storage material. In one embodiment, the rhodium is iron activated rhodium. In some embodiments, the washcoat layer further comprises a support oxide.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a functional block diagram illustrating a catalyst configuration for multi-zoned synergized-PGM (SPGM) catalysts, herein referred to as SPGM Type 1 and Type 2 catalysts, according to an embodiment.

FIG. 2 is a functional block diagram illustrating a catalyst configuration for a multi-zoned SPGM catalyst, herein referred to as SPGM Type 3 catalyst, according to an embodiment.

FIG. 3 is a graphical representation illustrating TWC low perturbation isothermal oscillating test results comparing NO_{X}, CO, and THC conversions for aged multi-zoned SPGM Type 1, Type 2, and Type 3 catalysts as well as for an aged PGM Original Equipment Manufacturer (OEM) reference catalyst, according to an embodiment.

FIG. 4 is a graphical representation illustrating TWC isothermal steady-state sweep test results comparing NO conversions at specific R-values for aged multi-zoned SPGM Type 1, Type 2, and Type 3 catalysts as well as for an aged PGM OEM reference catalyst, according to an embodiment.

FIG. 5 is a graphical representation illustrating TWC isothermal steady-state sweep test results comparing HC conversions at specific R-values for aged multi-zoned SPGM Type 1, Type 2, and Type 3 catalysts as well as for an aged PGM OEM reference catalyst, according to an embodiment.

FIG. 6 is a graphical representation illustrating TWC light-off (LO) test results comparing T₅₀ temperatures for NO, CO, and THC conversions for aged multi-zoned SPGM Type 1, Type 2, and Type 3 catalysts as well as for an aged PGM OEM reference catalyst, according to an embodiment.

### DETAILED DESCRIPTION

The present disclosure is described herein in detail with reference to embodiments illustrated in the drawings, which form a part hereof. Other embodiments may be used and/or other modifications may be made without departing from the scope or spirit of the present disclosure. The illustrative embodiments described in the detailed description are not meant to be limiting of the subject matter presented.

Definitions

As used here, the following terms have the following definitions:

“Blank zone” refers to a portion of a catalyst system or catalytic converter that is uncatalyzed (e.g., no catalytic material compositions, just a bare substrate).

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Catalytic activity” refers to the percentage of conversion of pollutants of interest in a catalytic converter.

“Catalyst Zone” refers to a catalytic material tailored to specific functions depending on the application and located on (directly or indirectly) a catalyst layer over a portion of the catalyst layer starting at one end.

“Conversion” refers to the chemical alteration of at least one material into one or more other materials.

“Impregnation” refers to the process of imbuing or saturating a solid layer with a liquid compound or the diffusion of some element through a medium or substance.

“Incipient wetness (IW)” refers to the process of adding solution of catalytic material to a dry support oxide powder until all pore volume of support oxide is filled out with solution and mixture goes slightly near saturation point.

“Inlet zone” refers to a location within a catalyst that originates at the inlet end of a catalyst layer, which is the end the exhaust gas enters first, and ends at an axial distance down the catalyst layer towards the outlet end, but extends a distance that is less than the entire distance of the catalyst layer.

“Lambda (λ)” refers to the ratio of actual air-fuel ratio to stoichiometric air-fuel ratio.

“Light-off (LO)” refers to the time elapsed from an engine cold start to the point of 50 percent pollutant conversion.

“Milling” refers to the operation of breaking a solid material into a desired grain or particle size.

“Original Equipment Manufacturer (OEM)” refers to a manufacturer of a new vehicle or a manufacturer of any part or component that is originally installed in a new vehicle's certified emission control system.

“Outlet zone” refers to a location that originates at the outlet end of a catalyst layer, which is the end from which the exhaust gas exits, and ends at an axial distance up the catalyst layer towards the inlet end, but extends a distance that is less than the entire distance of the catalyst layer.

“Overcoat (OC) layer” refers to a catalyst layer of at least one coating that can be deposited onto at least one washcoat layer or impregnation layer.

“Oxygen storage capacity (OSC)” refers to the ability of materials used as OSM in catalysts to store oxygen at lean conditions and to release it at rich conditions.

“Oxygen storage material (OSM)” refers to a material that absorbs oxygen from oxygen rich gas flows and further release the oxygen into oxygen deficient gas flows.

“Platinum group metals (PGM)” refers to platinum, palladium, ruthenium, iridium, osmium, and rhodium.

“R-value” refers to the value obtained by dividing the reductant components to oxidant components within a gas flow. R-value greater than about 1.0 refers to rich conditions. R-value less than about 1.0 refers to lean conditions. R-value equal to about 1.0 refers to stoichiometric condition.

“Spinel” refers to any minerals of the general formulation AB₂O₄ where the A ion and B ion are each selected from mineral oxides, such as, for example magnesium, iron, zinc, manganese, aluminum, chromium, titanium, niobium, cobalt, nickel, or copper, amongst others.

“Substrate” refers to any material of any shape or configuration that yields a sufficient surface area for depositing a washcoat layer and/or an overcoat layer.

“Support oxide” refers to porous solid oxides, typically mixed metal oxides, which are used to provide a high surface area that aids in distribution and exposure of catalysts to reactants, such as, for example NO_{X}, CO, and hydrocarbons.

“Synergized-PGM (SPGM) catalyst” refers to a PGM catalyst system that is synergized by a Zero-PGM compound employing different catalyst configurations.

“Synthesis method” refers to a process by which chemical reactions occur to form a catalyst from different precursor materials.

“T₅₀” refers to the temperature at which 50% of a material is converted.

“Three-way catalyst (TWC)” refers to a catalyst that performs the three simultaneous tasks of reduction of nitrogen oxides to nitrogen and oxygen, oxidation of carbon monoxide to carbon dioxide, and oxidation of unburnt hydrocarbons to carbon dioxide and water.

“Washcoat (WC) layer” refers to a catalyst layer of at least one coating, including at least one oxide solid that can be deposited onto a substrate.

“Zero-PGM (ZPGM) catalyst” refers to a catalyst completely or substantially free of platinum group metals (PGM).

Description of the Disclosure

The present disclosure describes multi-zoned synergized-platinum group metals (SPGM) catalysts produced according to varied catalyst configurations. The multi-zoned SPGM catalysts exhibit improved catalytic performance when compared with the catalytic performance of a high PGM-based Original Equipment Manufacturer (OEM) reference catalyst employed in TWC applications.

Material Composition of PGM Layers Employed Within Multi-Zoned SPGM Catalysts

In some embodiments, a PGM composition includes platinum (Pt), palladium (Pd), ruthenium (Ru), iridium (Ir), and rhodium (Rh), either by themselves, or in combinations thereof employing different loadings. In these embodiments, the PGM composition within the catalyst configurations includes an overcoat (OC) layer of ultra-low Rh loadings within a range from about 1 g/ft³ to about 10 g/ft³, deposited onto either support oxides in combination with a rare-earth (RE) metals-based OSM, or RE metals-based OSM alone. Further to these embodiments, the catalyst configurations include zoned-impregnation (ZIMP) and impregnation (IMP) layers with varied high PGM-based loadings of Pd within a range from about 10 g/ft³ to about 100 g/ft³, alone or in combination with Ba loadings. Still further to these embodiments support oxides include alumina (Al₂O₃), doped Al₂O₃, zirconia (ZrO₂), doped ZrO₂, CeO₂, TiO₂, Nb₂O₅, SiO₂, or mixtures thereof, amongst others. In these embodiments, doping materials within doped support oxides include Ca, Sr, Ba, Y, La, Ce, Nd, Pr, Nb, Si, or Ta oxides, amongst others. Further to these embodiments, RE-based OSM includes Pr, Ce, and Nd, or mixtures thereof, amongst others.

In an example, the PGM composition within the OC layer includes ultra-low PGM loadings of about 4.3 g/ft³ Rh deposited onto a mixture of doped ZrO₂ and RE metals-based OSM. In another example, the PGM composition within the OC layer includes ultra-low PGM loadings of about 4.3 g/ft³ Rh composition metallized with Fe₂O₃ deposited onto a Ce-based OSM. In this example, the ZIMP layers include inlet zones with a PGM composition with loadings of about 32 g/ft³ Pd and outlet zones with a PGM composition with loadings of about 16 g/ft³ Pd, alone or in combination with 0.5M Ba, respectively. Further to this example, the IMP layers include a PGM composition with loadings of about 36.57 g/ft³ Pd.

Material Compositions of ZPGM Layers Employed Within Multi-Zoned SPGM Catalysts

In some embodiments, a ZPGM composition includes binary spinel structures with a general formulation A_{X}B_{3-X}O₄ in which X is a variable representing molar ratios within a range from about 0.01 to about 2.99. In these embodiments, A and B can be implemented as Na, K, Mg, Ca, Sr, Ba, Cr, Mn, Fe, Co, Ni, Cu, Zn, Cd, Al, Ti, Nb, Ce, La, Pr, Nd, Sm, Dy, In, or mixtures thereof, amongst others. Further to these embodiments, the binary spinel structures are deposited onto support oxides. Examples of support oxides include alumina (Al₂O₃), doped Al₂O₃, zirconia (ZrO₂), doped ZrO₂, doped Al₂O₃—ZrO₂, TiO₂, Nb₂O₅, SiO₂, or mixtures thereof, amongst others.

In an example, the ZPGM composition is implemented as a binary spinel structure of copper (Cu) and manganese (Mn). In this example, the Cu—Mn spinel structure is produced using a general formulation Cu_{X}Mn_{3-X}O₄ in which X takes a value of about 1.5 for a Cu_{1.5}Mn_{1.5}O₄ binary spinel structure. Further to this example, the Cu_{1.5}Mn_{1.5}O₄ binary spinel structure is deposited onto a doped Al₂O₃—ZrO₂ support oxide.

Multi-Zoned SPGM Catalyst Configurations and Production

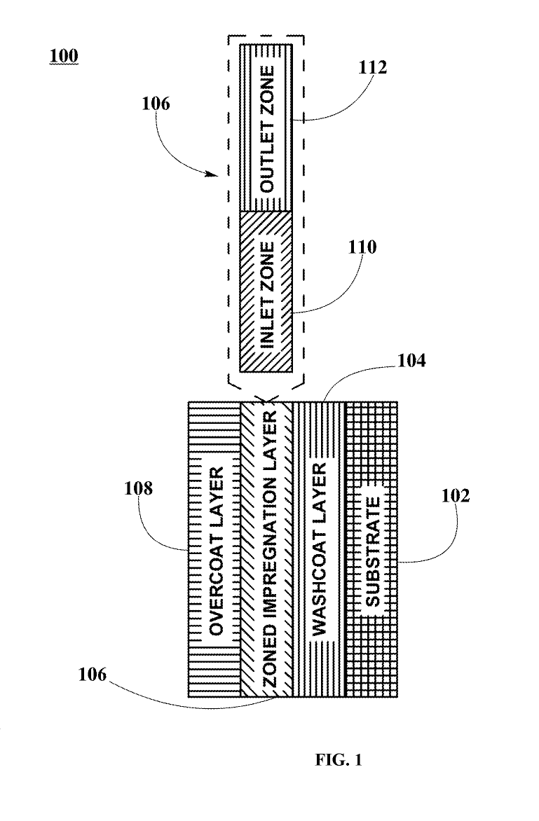

FIG. 1 is a functional block diagram illustrating a catalyst configuration for multi-zoned synergized-PGM (SPGM) catalysts, herein referred to as SPGM Type 1 and Type 2 catalysts, according to an embodiment. In FIG. 1, catalyst configuration 100 includes substrate 102, WC layer 104, ZIMP layer 106, and OC layer 108. In FIG. 1, ZIMP layer 106 further includes inlet zone 110 and outlet zone 112. In some embodiments, WC layer 104 is coated onto substrate 102. In these embodiments, ZIMP layer 106 is impregnated onto WC layer 104. Further to these embodiments, OC layer 108 is coated onto ZIMP layer 106.

SPGM Type 1 Catalyst Configuration and Production

In some embodiments, a SPGM catalyst, herein referred to as SPGM Type 1 catalyst, is configured with WC layer 104 comprising a doped Al₂O₃ support oxide combined with Ce-based OSM, and further coated onto substrate 102. In these embodiments, ZIMP layer 106 includes a 2-inches inlet zone of a Pd loading of about 32 g/ft³ and a 3.12-inches outlet zone of a Pd loading of about 16 g/ft³, each zone impregnated onto associated portion of WC layer 104. Further to these embodiments, OC layer 108 includes ultra-low PGM loadings of about 4.3 g/ft³ of Rh deposited onto doped ZrO₂ support oxide that is combined with a RE-based OSM.

In some embodiments, the production of the WC layer for SPGM Type 1 catalyst begins with the preparation of a solution comprising a doped Al₂O₃ support oxide and Ce-based OSM mixed at a ratio of about 1:1 by weight. In these embodiments, the doped Al₂O₃ support oxide is milled with water to produce a slurry of doped Al₂O₃ support oxide and Ce-based OSM. Further to these embodiments, the slurry of doped Al₂O₃ support oxide and Ce-based OSM is then coated onto the substrate and further calcined at about 550° C. for about 4 hours to produce the WC layer.

In some embodiments, the production of the ZIMP layer for SPGM Type 1 catalyst begins by separately preparing solutions of Pd nitrate with PGM loadings of about 32 g/ft³ Pd and about 16 g/ft³ Pd for the inlet and outlet zones, respectively. In these embodiments, the first Pd nitrate solution (32 g/ft³) is impregnated onto a portion of the WC layer to produce the inlet zone and then calcined at about 550° C. for about 4 hours to produce the inlet zone IMP layer within ZIMP layer. Further to these embodiments, the second Pd nitrate solution (16 g/ft³) is impregnated onto another portion of the WC layer to produce the outlet zone. In these embodiments, after impregnating the Pd onto the back zone of WC layer is calcined at about 550° C. for about 4 hours to produce the ZIMP layer.

In some embodiments, the production of the OC layer for SPGM Type 1 catalyst begins with the preparation of a solution of Rh nitrate with PGM loadings of about 4.3 g/ft³ Rh. In these embodiments, the doped ZrO₂ support oxide and RE metals-based OSM are mixed at a ratio of about 60:40 by weight, and further mixed with water and milled. Further to these embodiments, the doped ZrO₂ support oxide and RE metals-based OSM slurry is metallized with the Rh nitrate solution to produce a slurry of PGM/(doped ZrO₂+RE metals-based OSM). In these embodiments, the slurry of PGM/(doped ZrO₂+RE metals-based OSM) is coated onto the ZIMP layer, and further dried and calcined at a temperature of about 550° C. for about 4 hours to produce the SPGM Type 1 catalyst.

SPGM Type 2 Catalyst Configuration and Production

In some embodiments, a SPGM catalyst, herein referred to as SPGM Type 2 catalyst, is configured according to catalyst configuration 100, as described previously above in FIG. 1. In these embodiments, SPGM Type 2 catalyst includes WC layer 104 substantially similar in composition to the WC layer implemented for SPGM Type 1 catalyst. Further to these embodiments, ZIMP layer 106 includes a 2-inches inlet zone of a Pd loading of about 32 g/ft³ with Ba loadings of about 0.5M and a 3.12-inches outlet zone of a Pd loading of about 16 g/ft³ with Ba loadings of about 0.5M, each zone impregnated onto associated portion of WC layer 104, respectively. In these embodiments, OC layer 108 includes ultra-low PGM loadings of about 4.3 g/ft³ of Rh activated with Fe₂O₃ deposited onto doped ZrO₂ support oxide that is combined with a RE metals-based OSM.

In some embodiments, the production of the WC layer for SPGM Type 2 is performed in a substantially similar manner as described previously above for SPGM Type 1 catalyst. In these embodiments, the production of the ZIMP layer for SPGM Type 2 catalyst begins by separately preparing solutions of Pd nitrate with PGM loadings of about 32 g/ft³ Pd with Ba loadings of about 0.5M, and about 16 g/ft³ Pd with Ba loadings of about 0.5M, for the inlet and outlet zones, respectively. Further to these embodiments, the first Pd nitrate+Ba solution is impregnated onto a portion of the WC layer to produce the inlet zone and then calcined at about 550° C. for about 4 hours to produce the inlet zone IMP layer within ZIMP layer. Still further to these embodiments, the second Pd nitrate+Ba solution is impregnated onto another portion of the WC layer to produce the outlet zone. In these embodiments, after the impregnation of the Pd+Ba solutions onto the WC layer is calcined at about 550° C. for about 4 hours to produce the ZIMP layer.

In some embodiments, the production of the OC layer for SPGM Type 2 catalyst begins with the preparation of a base metal nitrate solution. In these embodiments, the base metal nitrate solution is implemented as a Fe nitrate solution. Further to these embodiments, the Fe nitrate solution is drop-wise added to a RE metals-based OSM support oxide powder via incipient wetness (IW) methodology employing a Fe loading from about 1 wt % to about 10 wt %. In an example, a 7wt % Fe loading is employed. Still further to these embodiments, the Fe-doped RE metals-based OSM is then dried at 120° C. overnight and further calcined in a temperature range from about 600° C. to about 800° C., preferably at about 750° C., for about 5 hours. In these embodiments, the calcined material of Fe₂O₃ and RE metals-based OSM support oxide is subsequently ground into fine powder, and further milled with water to produce a slurry of Fe₂O₃/RE metals-based OSM support oxide. Further to these embodiments, the slurry of Fe₂O₃/RE metals-based OSM is metallized with the Rh nitrate solution to produce a slurry of Fe-activated Rh and RE metals-based OSM having a loading of about 4.3 g/ft³ Rh. Still further to these embodiments, the slurry of Fe-activated Rh and RE-based OSM is coated onto the WC layer, and further dried and calcined at a temperature of about 550° C. for about 4 hours to produce the SPGM Type 2 catalyst.

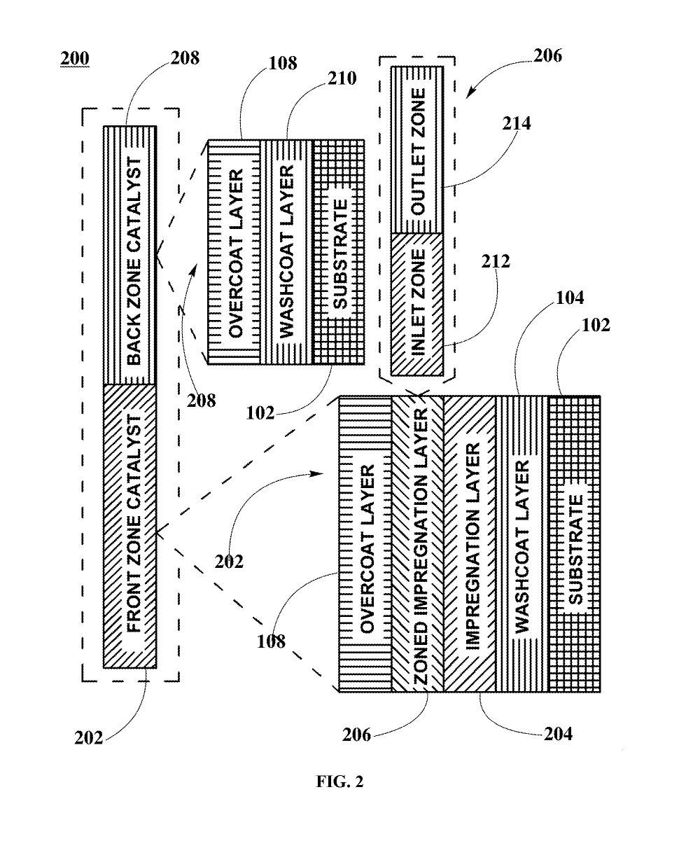

FIG. 2 is a functional block diagram illustrating a catalyst configuration for a multi-zoned SPGM catalyst, herein referred to as SPGM Type 3 catalyst, according to an embodiment. In FIG. 2, catalyst configuration 200 includes front-zone catalyst 202 and back-zone catalyst 208. Front-zone catalyst 202 further includes substrate 102, WC layer 104, IMP layer 204, ZIMP layer 206, and OC layer 108. Back-zone catalyst 208 further includes substrate 102, WC layer 210, and OC layer 108. ZIMP layer 206 further includes inlet zone 212 and outlet zone 214. In FIG. 2, elements having substantially similar element numbers from previous figures function in a substantially similar manner.

SPGM Type 3 Catalyst Configuration and Production

In some embodiments, a SPGM catalyst, herein referred to as SPGM Type 3 catalyst, is configured according to catalyst configuration 200, as described previously above in FIG. 2. In these embodiments, SPGM Type 3 catalyst includes a front-zone catalyst and a back-zone catalyst with a substrate and OC layers that are substantially similar in composition to the substrate and OC layers described previously above for SPGM Type 2 catalyst. Further to these embodiments, the front-zone catalyst is configured with a WC layer that is substantially similar to the WC layer described previously above for SPGM Type 2 catalyst. Still further to these embodiments, IMP layer 204 includes Pd loadings of about 36.57 g/ft³ Pd with Ba loadings of about 0.5M coated onto the WC layer. In these embodiments, the front-zone catalyst includes ZIMP layer 206 with 2-inches inlet zone 212 of a Pd loading of about 37.65 g/ft³ and 3.12-inches blank outlet zone 214, each zone impregnated onto associated portion of the WC layer. Further to these embodiments, the back-zone catalyst includes a WC layer of a Cu_{1.5}Mn_{1.5}O₄ deposited onto doped Al₂O₃—ZrO₂ support oxide. In these embodiments, the back-zone catalyst further includes an OC layer that is substantially similar in composition to the OC layer described previously above for SPGM Type 2 catalyst.

In some embodiments, the production of the WC and OC layers with the front-zone catalyst is performed in a substantially similar manner as described previously above for SPGM Type 2 catalyst. In these embodiments, the production of the IMP layer begins with the preparation of a solution of Pd nitrate with PGM loadings of about 36.57 g/ft³ Pd with Ba loadings of about 0.5M. Further to these embodiments, the solution of Pd mitrate+Ba solution is impregnated onto the WC layer and further calcined at about 550° C. for about 4 hours to produce the IMP layer.

In some embodiments, the production of the ZIMP layer within the front-zone catalyst begins with the preparation of a solution of Pd nitrate with PGM loadings of about 37.65 g/ft³ Pd with Ba loadings of about 0.5M, and a blank zone, for the inlet and outlet zones, respectively. In these embodiments, the Pd mitrate+Ba solution is impregnated onto a portion of the IMP layer to produce the inlet zone. Further to these embodiments, the 3.12-inches outlet zone is left as blank to produce the blank outlet zone. Still further to these embodiments, after the impregnation of the Pd+Ba solution and blank onto the IMP layer, the Pd+Ba coating and blank are further calcined at about 550° C. for about 4 hours to produce the ZIMP layer. In these embodiments, after the OC layer is coated onto the ZIMP layer, the coating is further calcined at about 550° C. for about 4 hours to produce the front-zone catalyst.

In some embodiments, the production of the WC layer for the back-zone catalyst begins with the preparation of the supported Cu—Mn spinel powder. In these embodiments, the powder of the Cu—Mn spinel composition is produced by mixing appropriate amounts of Mn nitrate solution and Cu nitrate solution to produce a mixed oxide nitrate solution at an appropriate molar ratio for Cu_{1.5}Mn_{1.5}O₄. Further to these embodiments, the Cu and Mn nitrate solution is drop-wise added to the doped Al₂O₃—ZrO₂ support oxide powder via IW methodology. Still further to these embodiments, the Cu—Mn/doped Al₂O₃—ZrO₂ support oxide powder is then dried at about 125° C. overnight and further calcined at a temperature range from 650° C. to about 950° C., preferably at about 800° C., for about 5 hours. In these embodiments, the calcined material of Cu—Mn/doped Al₂O₃—ZrO₂ is subsequently ground into fine powder, and further mixed with water to produce a slurry of Cu—Mn/doped Al₂O₃—ZrO₂. Further to these embodiments, the slurry of Cu—Mn/doped Al₂O₃—ZrO₂ is then coated onto the substrate and further calcined at about 550° C. for about 4 hours to produce the WC layer.

In some embodiments, the production of the OC layer for the back-zone catalyst is performed in a substantially similar manner as described previously above for SPGM Type 2 catalyst. In these embodiments, the OC layer is coated onto the WC layer and further calcined at about 550° C. for about 4 hours to produce the back-zone catalyst.

In some embodiments, after the production of the front-zone and back-zone catalyst, core lengths of about 1 inch are cut from the front- and back-zone catalysts, respectively, and coupled to produce the SPGM Type 3 catalyst.

PGM OEM Reference Catalyst

In some embodiments, a PGM OEM reference catalyst is employed to assess and compare its catalytic performance with the catalytic performance of the SPGM Type 1, Type 2, and Type 3 catalysts. In these embodiments, the PGM OEM reference catalyst is a high PGM-based catalyst with PGM loadings of about 70.1 g/ft³ Pd and about 3.9 g/ft³ Rh, resulting in a total PGM loading of about 74 g/ft³. Further to these embodiments, the PGM OEM reference catalyst includes support oxide compositions of doped Al₂O₃ and Ce-based OSM.

Aging and Testing Conditions for the Aforementioned Catalysts

In some embodiments, the multi-zoned SPGM catalysts and PGM OEM reference catalyst are aged employing a fuel cut ZDAKW aging cycle protocol. In these embodiments, the multi-zoned SPGM Type 1, Type 2, and Type 3 catalysts and PGM OEM reference catalyst are aged employing the fuel cut ZDAKW aging cycle protocol at a temperature of about 1050° C. for about 20 hours. Further to these embodiments, the fuel cut ZDAKW aging cycle protocol employs a gas stream of varying composition that is passed through the aforementioned SPGM catalysts and the PGM OEM reference catalyst.

In some embodiments, the fuel cut ZDAKW aging cycle protocol includes a first stoichiometric mode, a fuel-cut mode, and a second stoichiometric mode. In these embodiments, the first stoichiometric mode is an aging segment that is performed at stoichiometric condition with lambda (λ) value of about 1.0 for about 355 seconds, and employing a gas stream composition including about 0.5% of CO, about 0.25% of O₂, about 10% of CO₂, about 10% of H₂O, and N₂ for the remaining amount. Further to these embodiments, the fuel-cut mode is an aging segment that is performed under a fuel-cut lean condition at λ value greater than about 1.0 for about 5 seconds, and employing a gas stream composition including about 0% of CO, about 16% of O₂, about 10% of CO₂, about 10% of H₂O, and N₂ for the remaining amount. In these embodiments, the second stoichiometric mode is an aging segment that is performed at stoichiometric λ value of about 1.0 for about 55 seconds, and employing a gas stream composition including about 0.5% of CO, about 0.25% of O₂, about 10% of CO₂, about 10% of H₂O, and N₂ for the remaining amount. Further to these embodiments, after about 20 hours of application of the modes within the aging cycle protocol, the temperature is cooled down from about 950° C. to about 200° C., while maintaining aging cycle.

In some embodiments, the aged multi-zoned SPGM Type 1, Type 2, and Type 3 catalysts and aged PGM OEM reference catalyst are subject to a plurality of test procedures to assess/verify significant catalytic activity, to determine and compare NO_{X} reduction and THC oxidation, and determine and compare light-off (LO) temperature T₅₀ for NO, CO, and THC conversions. In these embodiments, test procedures include: TWC low perturbation isothermal oscillating tests, TWC isothermal steady-state sweep tests, and TWC standard LO tests. Further to these embodiments, the test results provide data for analyzing the interactions between the catalytic layers within the multi-zoned SPGM catalysts.

TWC Isothermal Oscillating Test Procedure

In some embodiments, a TWC low perturbation oscillating test is conducted employing a flow reactor at inlet temperature of about 550° C. and feeding a TWC gas composition. In these embodiments, TWC gas composition includes about 8,000 ppm of CO, about 400 ppm of C₃H₆, about 100 ppm of C₃H₈, about 1,000 ppm of NO_{X}, about 2,000 ppm of H₂, about 10% of CO₂, about 10% of H₂O, and adjusted oxygen (O₂) quantity where the air-to-fuel ratio (AFR) oscillates around the stoichiometric condition. Further to these embodiments, average R-value is about 1.05 (close to stoichiometric condition) at a space velocity (SV) of about 90,000 hr⁻¹. Still further to these embodiments, the TWC low perturbation oscillating test is conducted employing a frequency of about 0.125 Hz and having an AFR span of about 0.8 to assess the catalytic activity of the aforementioned multi-zoned SPGM catalysts as well as a PGM OEM reference catalyst.

TWC Standard Isothermal Steady State Sweep Test Procedure

In some embodiments, a TWC standard isothermal steady-state sweep test is performed employing a flow reactor at inlet temperature of about 370° C., SV of about 90,000 hr⁻¹, from rich to lean conditions within a range of R-values from about 1.2 to about 0.85. In these embodiments, the TWC standard isothermal steady-state sweep test is performed to measure the NO, CO, and THC conversions. Further to these embodiments, the standard TWC gas stream composition includes about 8,000 ppm of CO, about 400 ppm of C₃H₆, about 100 ppm of C₃H₈, about 1,000 ppm of NO_{X}, about 2,000 ppm of H₂, about 10% of CO₂, and about 10% of H₂O. In these embodiments, the quantity of O₂ within the gas mix is varied to regulate the AFR. Further to these embodiments, results from TWC isothermal steady-state sweep tests are employed to determine and compare NO_{X} reduction and THC oxidation of the aforementioned multi-zoned SPGM and PGM OEM reference catalysts.

TWC Standard Light-Off Test Procedure

In some embodiments, a TWC standard light-off (LO) test is performed employing a flow reactor, in which temperature is increased from about 100° C. to about 500° C. at a rate of about 40° C./min, at SV of about 90,000 hr⁻¹, and feeding a standard TWC gas composition. In these embodiments, the standard TWC gas composition includes about 8,000 ppm of CO, about 400 ppm of C₃H₆, about 100 ppm of C₃H₈, about 1,000 ppm of NO_{X}, about 2,000 ppm of H₂, about 10% of CO₂, about 10% of H₂O, and about 0.7% of O₂, and having an average R-value of about 1.05 (close to stoichiometric condition). Further to these embodiments, the TWC standard LO test is performed to measure the LO temperature T₅₀ for NO, CO, and THC conversions of the aforementioned multi-zoned SPGM catalysts and PGM OEM reference catalyst.

TWC Performance of Multi-Zoned SPGM Catalysts

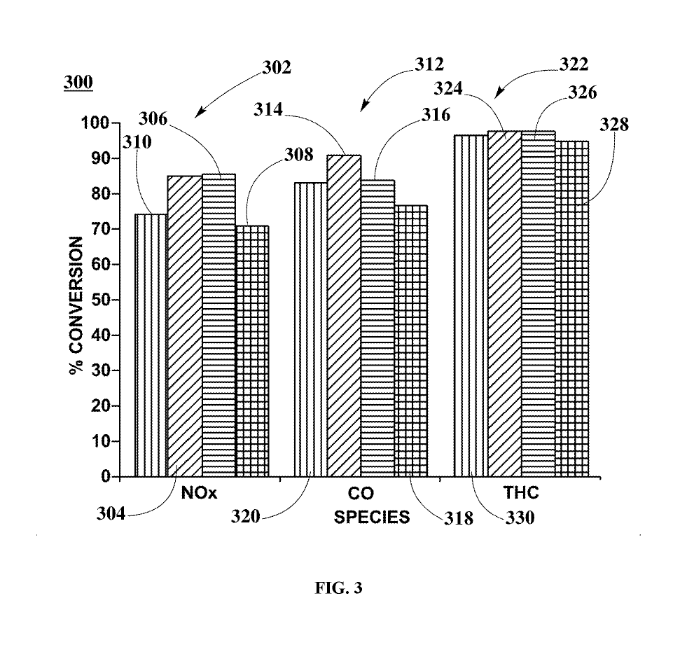

FIG. 3 is a graphical representation illustrating TWC low perturbation isothermal oscillating test results comparing NO_{X}, CO, and THC conversions for aged multi-zoned SPGM Type 1, Type 2, and Type 3 catalysts as well as for an aged PGM OEM reference catalyst, according to an embodiment. In FIG. 3, catalytic conversion comparison 300 includes conversion bar set 302, conversion bar set 312, and conversion bar set 322. Conversion bar set 302 further includes conversion bar 304, conversion bar 306, conversion bar 308, and conversion bar 310. Conversion bar set 312 further includes conversion bar 314, conversion bar 316, conversion bar 318, and conversion bar 320. Conversion bar set 322 further includes conversion bar 324, conversion bar 326, conversion bar 328, and conversion bar 330.

In some embodiments and referring to FIG. 3, conversion bar set 302, conversion bar set 312, and conversion bar set 322 illustrate NO_{X}, CO, and THC conversions, respectively, for the aforementioned aged multi-zoned SPGM catalysts and aged PGM OEM reference catalyst detailed in Table 1, below.

TABLE 1
NO_{X}, CO, and THC conversions for aged multi-zoned SPGM catalysts
(SPGM Type 1, Type 2, and Type 3 catalysts) as well as for an
aged PGM OEM reference catalyst, as illustrated in FIG. 3.

| | | | Associated |
|---|---|---|---|
| Type of Catalyst | Pollutant | % Conversion | Element |
| SPGM Type 1 | NO_{X} | 85.0 | 304 |
| SPGM Type 2 | NO_{X} | 85.5 | 306 |
| SPGM Type 3 | NO_{X} | 70.9 | 308 |
| PGM OEM reference | NO_{X} | 74.0 | 310 |
| SPGM Type 1 | CO | 90.8 | 314 |
| SPGM Type 2 | CO | 83.8 | 316 |
| SPGM Type 3 | CO | 76.7 | 318 |
| PGM OEM reference | CO | 83.1 | 320 |
| SPGM Type 1 | THC | 97.9 | 324 |
| SPGM Type 2 | THC | 97.8 | 326 |
| SPGM Type 3 | THC | 94.9 | 328 |
| PGM OEM reference | THC | 96.6 | 330 |

In some embodiments, the multi-zoned SPGM catalysts exhibit different NO_{X}, CO, and THC conversion levels. In these embodiments, the SPGM Type 1 catalyst exhibits about 85.0% NO_{X} conversion, about 90.8% CO conversion, and about 97.9% THC conversion. Further to these embodiments, the SPGM Type 2 catalyst exhibits about 85.5% NO_{X} conversion, about 83.8% CO conversion, and about 97.8% THC conversion. Still further to these embodiments, the SPGM Type 3 catalyst exhibits about 70.9% NO_{X} conversion, about 76.7% CO conversion, and about 94.9% THC conversion. In these embodiments, the PGM OEM reference catalyst exhibits about 74.0% NO_{X} conversion, about 83.1% CO conversion, and about 96.6% THC conversion.

In some embodiments, test results confirm that SPGM Type 1 and Type 2 catalysts exhibit greater conversion performance than SPGM Type 3 and high-loading PGM OEM reference catalysts. In these embodiments, the addition of the base metal oxide, Fe₂O₃, and the Ba within the inlet and outlet zones of the ZIMP layer of SPGM Type 2 provides no improvement in catalytic performance when compared with the catalytic performance achieved by SPGM Type 1 catalyst. Further to these embodiments, the test results confirm that the SPGM Type 1 catalyst exhibits a substantially similar NO_{X} conversion as SPGM Type 2 catalyst. Still further to these embodiments, the SPGM Type 1 exhibits a greater CO oxidation than SPGM Type 2 catalyst. In these embodiments, the SPGM Type 1 and Type 2 catalysts exhibit substantially similar catalytic activity in THC oxidation. Further to these embodiments, the SPGM Type 1 and Type 2 catalysts exhibit improved aging stability at the aging temperature of about 1050° C. employing the fuel cut ZDAKW aging cycle protocol.

In some embodiments, a comparison of the SPGM Type 3 catalyst (comprising 20% of the total PGM loading employed to produce SPGM Type 1 and Type 2 catalysts) with SPGM Type 1 and Type 2 catalysts as well as the high PGM-based OEM reference catalyst indicates that catalytic performance of SPGM Type 3 catalyst is substantially similar to the catalytic performance of the PGM OEM reference catalyst. In these embodiments, the SPGM Type 1, Type 2, and Type 3 catalysts as well as the PGM OEM reference catalyst exhibit substantially similar THC conversion performance, as illustrated in FIG. 3.

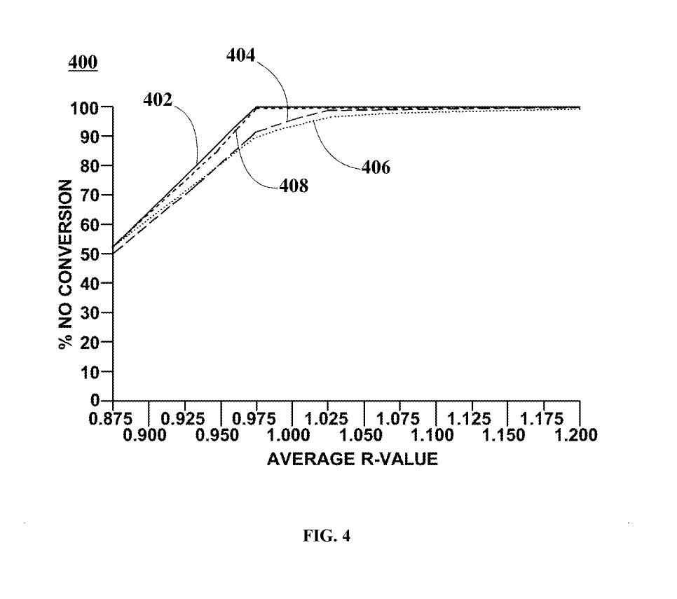

FIG. 4 is a graphical representation illustrating TWC isothermal steady-state sweep test results comparing NO conversions at specific R-values for aged multi-zoned SPGM Type 1, Type 2, and Type 3 catalysts as well as for an aged PGM OEM reference catalyst, according to an embodiment. In FIG. 4, conversion comparisons 400 includes NO conversion curve 402, NO conversion curve 404, NO conversion curve 406, and NO conversion curve 408.

In some embodiments, NO conversion curve 402 illustrates NO conversion associated with an aged SPGM Type 1 catalyst. In these embodiment, NO conversion curve 404 illustrates NO conversion associated with an aged SPGM Type 2 catalyst. Further to these embodiments, NO conversion curve 406 illustrates NO conversion associated with an aged SPGM Type 3 catalyst. Still further to these embodiments, NO conversion curve 408 illustrates NO conversion associated with an aged PGM OEM reference catalyst.

In some embodiments, the test results confirm that the SPGM Type 1 catalyst exhibits a significantly improved lean NO_{X} conversion when compared to the high PGM-based OEM reference catalyst. In these embodiments and at about an R-value of about 0.98, the SPGM Type 1 catalyst and PGM OEM reference catalysts exhibit a substantially similar NO_{X} conversion of about 99.96%. Further to these embodiments, the SPGM Type 2 and Type 3 catalysts exhibit substantially similar and improved lean NO_{X} conversions that are slightly lower than NO_{X} conversions achieved by SPGM Type 1 and PGM OEM reference catalysts. Still further to these embodiments and at about an R-value of about 0.98, the SPGM Type 2 and Type 3 catalysts exhibit a substantially similar NO_{X} conversion of about 89.94%.

In some embodiments, a comparison of SPGM Type 3 catalyst (including 20% of the total PGM loading employed to produce SPGM Type 1 and Type 2 catalysts) with SPGM Type 1 and Type 2 catalysts as well as the high PGM-based OEM reference catalyst indicates that the NO_{X} conversion performance of SPGM Type 3 catalyst is substantially and significantly comparable to NO_{X} conversion performance of SPGM Type 1 and Type 2 catalysts as well as the high PGM-based OEM reference catalyst. In these embodiments, the SPGM Type 1, Type 2, and Type 3 catalysts as well as the PGM OEM reference catalyst exhibit substantially similar rich NO_{X} conversion performance, as illustrated in FIG. 4.

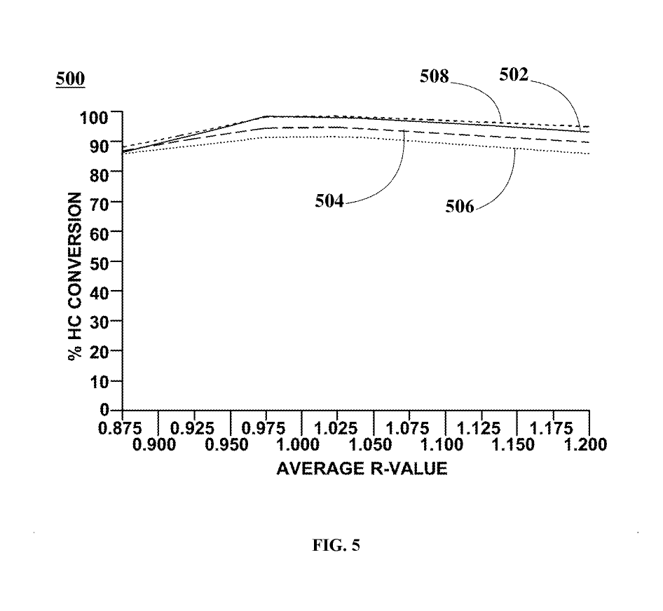

FIG. 5 is a graphical representation illustrating TWC isothermal steady-state sweep test results comparing HC conversions at specific R-values for aged multi-zoned SPGM Type 1, Type 2, and Type 3 catalysts as well as for an aged PGM OEM reference catalyst, according to an embodiment. In FIG. 5, conversion comparisons 500 includes THC conversion curve 502, THC conversion curve 504, THC conversion curve 506, and THC conversion curve 508.

In some embodiments, THC conversion curve 502 illustrates THC conversion associated with an aged SPGM Type 1 catalyst. In these embodiment, THC conversion curve 504 illustrates THC conversion associated with an aged SPGM Type 2 catalyst. Further to these embodiments, THC conversion curve 506 illustrates THC conversion associated with an aged SPGM Type 3 catalyst. Still further to these embodiments, THC conversion curve 508 illustrates THC conversion associated with an aged PGM OEM reference catalyst.

In some embodiments, the test results confirm that the SPGM Type 1 catalyst exhibits a substantially similar THC conversion performance when compared to the high PGM-based OEM reference catalyst. In these embodiments, the addition of the base metal oxide, Fe₂O₃, within the OC layer and the Ba within the inlet and outlet zones of the ZIMP layer of SPGM Type 2 provides no significant improvement in THC conversion performance of SPGM Type 2 catalyst compared to the THC conversion performance achieved by SPGM Type 1 catalyst. Further to these embodiments, the SPGM Type 2 and Type 3 catalysts exhibit substantially similar THC conversion performance that is slightly lower than THC conversion performance achieved by SPGM Type 1 and PGM OEM reference catalysts.

In some embodiments, the SPGM Type 1, Type 2, and Type 3 catalysts exhibit a highly significant stability in THC conversion that remains substantially similar throughout the entire range of R-values (rich to lean conditions) employed within the TWC isothermal steady-state sweep test. In these embodiments, a comparison of SPGM Type 3 catalyst (including 20% of the total PGM loading employed to produce SPGM Type 1 and Type 2 catalysts) with SPGM Type 1 and Type 2 catalysts as well as the high PGM-based OEM reference catalyst indicates that the THC conversion performance of SPGM Type 3 catalyst is substantially and significantly comparable to the THC conversion performance of SPGM Type 1 and Type 2 catalysts as well as the high PGM-based OEM reference catalyst, as illustrated in FIG. 5.

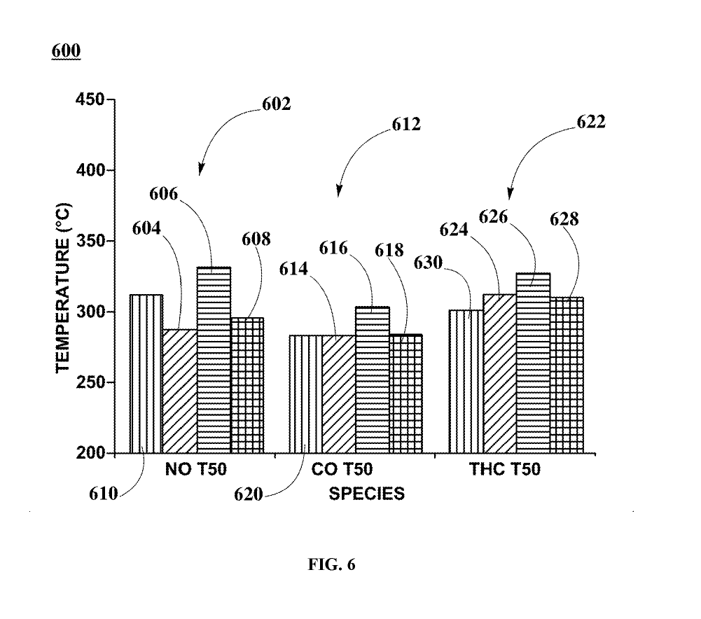

FIG. 6 is a graphical representation illustrating light-off (LO) test results comparing T₅₀ temperatures for NO, CO, and THC conversions of aged multi-zoned SPGM Type 1, Type 2, and Type 3 catalysts as well as for an aged PGM OEM reference catalyst, according to an embodiment. In FIG. 6, T50 comparison 600 includes T₅₀ comparison bar set 602, T₅₀ comparison bar set 612, and T₅₀ comparison bar set 622. T₅₀ comparison bar set 602 further includes bar 604, bar 606, bar 608, and bar 610. T₅₀ comparison bar set 612 further includes bar 614, bar 616, bar 618, and bar 620. T₅₀ comparison bar set 622 further includes bar 624, bar 626, bar 628, and bar 630.

In some embodiments and referring to FIG. 6, Tso comparison bar set 602, T₅₀ comparison bar set 612, and T₅₀ comparison bar set 622 illustrate LO T₅₀ temperatures for NO, CO, and THC conversions, respectively, for the aforementioned aged multi-zoned SPGM catalysts and aged PGM OEM reference catalyst detailed in Table 2, below.

TABLE 2
LO T₅₀ temperatures for NO, CO, and THC conversions
for aged SPGM catalysts (SPGM Type 1, Type 2, and
Type 3 catalysts) as well as for an aged PGM OEM
reference catalyst, as illustrated in FIG. 6.

| | | T₅₀ | |
|---|---|---|---|
| | | Temperature | Associated |
| Type of Catalyst | Pollutant | (° C.) | Element |
| SPGM Type 1 | NO_{X} | 288 | 604 |
| SPGM Type 2 | NO_{X} | 327 | 606 |
| SPGM Type 3 | NO_{X} | 294 | 608 |
| PGM OEM reference | NO_{X} | 311 | 610 |
| SPGM Type 1 | CO | 285 | 614 |
| SPGM Type 2 | CO | 305 | 616 |
| SPGM Type 3 | CO | 285 | 618 |
| PGM OEM reference | CO | 284 | 620 |
| SPGM Type 1 | THC | 310 | 624 |
| SPGM Type 2 | THC | 320 | 626 |
| SPGM Type 3 | THC | 306 | 628 |
| PGM OEM reference | THC | 303 | 630 |

In some embodiments, the SPGM catalysts exhibit different LO Tso temperatures. In these embodiments, the SPGM Type 1 catalyst exhibits about 288° C., about 285° C., and about 310° C. LO T₅₀ temperatures for NO, CO, and THC conversions, respectively. Further to these embodiments, the SPGM Type 2 catalyst exhibits about 327° C., about 305° C., and about 320° C. LO Tso temperatures for NO, CO, and THC conversions, respectively. Still further to these embodiments, the SPGM Type 3 catalyst exhibits about 294° C., about 285° C., and about 306° C. LO T₅₀ temperatures for NO, CO, and THC conversions, respectively. In these embodiments, the PGM OEM reference catalyst exhibits about 311° C., about 284° C., and about 303° C. LO T₅₀ temperatures for NO, CO, and THC conversions, respectively.

In some embodiments, test results confirm that SPGM Type 1 catalyst exhibits lower LO T₅₀ temperatures for NO, CO, and THC conversions when compared with SPGM Type 2 and Type 3 catalysts. In these embodiments, a comparison of the SPGM catalysts with the high PGM-based OEM reference catalyst indicates that LO T₅₀ temperatures of the SPGM Type 1 catalyst are substantially and significantly improved as the LO T₅₀ temperatures of the high PGM-based OEM reference catalyst. Further to these embodiments, the addition of the base metal oxide, Fe₂O₃, within the OC layer and the Ba within the inlet and outlet zones of the ZIMP layer of SPGM Type 2 provides no improvement in catalytic performance of SPGM Type 2 catalyst when compared with the catalytic performance achieved by SPGM Type 1 catalyst, as illustrated in FIG. 6 by the NO, CO, and THC bars. Still further to these embodiments, the SPGM Type 3 catalyst (including 20% of the total PGM loading employed to produce SPGM Type 1 and Type 2 catalysts) exhibits significantly similar LO T₅₀ temperatures when compared to SPGM Type 1 catalyst.

In summary, the multi-zoned SPGM Type 1, Type 2, and Type 3 catalysts are produced for a variety of TWC applications. In the OC layer within SPGM Type 1 and Type 2 catalysts, the total ultra-low PGM loading of Rh employed is fixed at about 4.3 g/ft³. Further, the SPGM Type 2 catalyst is configured with an OC layer including Fe₂O₃ and RE metals-based OSM, and a ZIMP layer including a PGM-based Pd composition with 0.5M of Ba loadings. Still further, the SPGM Type 3 catalyst is produced as a three-zoned SPGM catalyst in which the total ultra-low PGM loadings are about 20% of the PGM loadings employed to produce SPGM Type 1 and Type 2 catalysts.

Referring to FIGS. 3-6, the SPGM Type 1 catalyst, without loadings of Fe or Ba, exhibits the most improved catalytic performance when compared with the catalytic performances achieved by SPGM Type 2 catalyst and high PGM-based OEM reference catalyst. Further, the SPGM Type 3 catalyst (including 20% of the total PGM loading employed to produce SPGM Type 1 and Type 2 catalysts) exhibits a significant catalytic performance that is comparable with the catalytic performance of the high PGM-based OEM reference catalyst. The comparable conversion performance of the SPGM Type 3 catalyst, employing low PGM loadings, when compared to SPGM Type 1 and Type 2 catalysts and high PGM based OEM reference catalyst is attributed to the synergistic interactions between the spinel-based ZPGM layer and the PGM OC layer.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

1. A catalyst system for treating an exhaust stream of a combustion engine, comprising:
a front zone catalyst region and a back zone catalyst region disposed downstream of the front zone catalyst region, wherein the front zone catalyst region comprises:
a substrate;
a washcoat layer overlying the substrate;
an impregnation layer overlying the washcoat layer, the impregnation layer comprising a platinum group metal;
a zoned-impregnation layer overlying the impregnation layer, the zoned-impregnation layer including an inlet zone and an outlet zone downstream of the inlet zone, the inlet zone comprising a platinum group metal and the outlet zone comprising a blank zone; and
an overcoat layer overlying the zoned-impregnation layer and comprising iron activated rhodium and a rare earth element-based oxygen storage material;
the back zone catalyst region comprising:
a substrate;
a washcoat layer overlying the substrate, the washcoat layer comprising a support oxide and a binary spinel structure of the general formula A_{X}B_{3-X}O₄; and
an overcoat layer overlying the washcoat layer and comprising iron activated rhodium and a rare earth element-based oxygen storage material.

2. The catalyst system of claim 1, wherein Xis a variable ranging from 0.01 to 2.99.

3. The catalyst system of claim 1, wherein A and B are selected from the group consisting of sodium, potassium, magnesium, calcium, strontium, barium, chromium, manganese, iron, cobalt, nickel, copper, zinc, cadmium aluminum, titanium, niobium, indium, cerium, lanthanum, praseodymium, neodymium, samarium, and dysprosium.

4. The catalyst system of claim 1, wherein the binary spinel comprises a Cu—Mn spinel structure.

5. The catalytic system of claim 4, wherein the Cu—Mn spinel structure has the formula Cu_{1.5}Mn_{1.5}O₄.

6. The catalyst system of claim 1, wherein the platinum group metal in the impregnation layer is palladium having a loading from about 10 g/ft³ to about 100 g/ft³.

7. The catalyst system of claim 6, wherein the platinum group metal in the impregnation layer is palladium having a loading of about 30 g/ft³ to 40 g/ft³.

8. The catalyst system of claim 1, wherein the impregnation layer further comprises barium.

9. The catalyst system of claim 1, wherein the inlet zone of the zoned-impregnation layer is disposed towards an inlet end of the catalyst system, and the outlet zone of the zoned-impregnation layer is disposed towards an outlet end of the catalyst system.

10. The catalyst system of claim 1, wherein the platinum group metal in the inlet zone is palladium having a loading from about 10 g/ft³ to about 100 g/ft³.

11. The catalyst system of claim 10, wherein the platinum group metal in the inlet zone is palladium having a loading of about 30 g/ft³ to 40 g/ft³.

12. The catalyst system of claim 1, wherein the inlet zone of the zoned-impregnation layer further comprises barium.

13. The catalyst system of claim 1, wherein the overcoat layer of the front zone catalyst region comprises rhodium having a loading from about 1 to about 10 g/ft³.

14. The catalyst system of claim 13, wherein the overcoat layer of the front zone catalyst region comprises rhodium having a loading of about 4.3 g/ft³.

15. The catalyst system of claim 1, wherein the iron loading in the overcoat layer of the front zone catalyst region is from about 1 to about 10 percent by mass based on the total mass of the overcoat layer.

16. The catalyst system of claim 15, wherein the iron loading in the overcoat layer of the front zone catalyst region is about 7 percent by mass based on the total mass of the overcoat layer.

17. The catalyst system of claim 1, wherein the washcoat layer of the front zone catalyst region comprises a rare earth element-based oxygen storage material and a support oxide, wherein the amount of rare earth element-based oxygen storage material to support oxide is a 1:1 mass ratio.

18. The catalyst system of claim 17, wherein the support oxide in the washcoat layer of the front zone region is selected from the group consisting of alumina, doped alumina, zirconia, doped zirconia, cerium oxide, titanium oxide, niobium oxide, silicon dioxide, and combinations thereof.

19. The catalyst system of claim 18, wherein the doped support oxide is doped with an oxide selected from the group consisting of calcium, strontium, barium, yttrium, lanthanum, neodymium, praseodymium, niobium, silicon, tantalum, and combinations thereof.

20. The catalyst system of claim 1, wherein the rare earth elements in the overcoat and washcoat layers of the front zone catalyst region are selected from the group consisting of praseodymium, cerium, neodymium, and combinations thereof

21. The catalyst system of claim 1, wherein the washcoat layer of the front zone catalyst region comprises doped aluminum oxide (Al₂O₃) and a cerium based oxygen storage material (Ce-based OSM) in a 1:1 mass ratio.

22. The catalyst system of claim 1, wherein the support oxide in the washcoat layer of the back zone catalyst region is selected from the group consisting of alumina, doped alumina, zirconia, doped zirconia, cerium oxide, titanium oxide, niobium oxide, silicon dioxide, and combinations thereof.

23. The catalyst system of claim 22, wherein the doped support oxide is doped with an oxide selected from the group consisting of calcium, strontium, barium, yttrium, lanthanum, neodymium, praseodymium, niobium, silicon, tantalum, and combinations thereof.

24. The catalyst system of claim 1, wherein the support oxide in the washcoat layer of the back zone catalyst region comprises doped Al₂O₃—ZrO₂.

25. The catalyst system of claim 1, wherein the overcoat layer of the back zone catalyst region comprises rhodium having a loading from about 1 to about 10 g/ft³.

26. The catalyst system of claim 25, wherein the overcoat layer of the back zone catalyst region comprises rhodium having a loading of about 4.3 g/ft³.

27. The catalyst system of claim 1, wherein the iron loading in the overcoat layer of the back zone catalyst region is from about 1 to about 10 percent by mass based on the total mass of the overcoat layer.

28. The catalyst system of claim 27, wherein the iron loading in the overcoat layer of the back zone catalyst region is about 7 percent by mass based on the total mass of the overcoat layer.

29. A catalyst system for treating an exhaust stream of a combustion engine, comprising:
a substrate;
a washcoat layer overlying the substrate;
a zoned-impregnation layer impregnated onto the washcoat layer, the zoned-impregnation layer including an inlet zone comprising a platinum group metal and an outlet zone comprising a platinum group metal, wherein a loading of the platinum group metal in the outlet zone is less than a loading of the platinum group metal in the inlet zone; and
an overcoat layer overlying the zoned-impregnation layer and comprising rhodium and a rare earth element-based oxygen storage material.

30. The catalyst system of claim 29, wherein the rhodium is iron activated rhodium.

31. The catalyst system of claim 29, wherein the overcoat layer further comprises a support oxide.
